(19) United States
(12) Patent Application Publication
(10) Pub. No.: US 2025/0298165 A1
(43) Pub. Date: Sep. 25, 2025

(54) CHARACTERIZING COUPLING QUALITY USING AMPLITUDE SPECTRA

(71) Applicant: Schlumberger Technology Corporation, Sugar Land, TX (US)

(72) Inventor: Jiuxun Yin, Katy, TX (US)

(21) Appl. No.: 18/635,875

(22) Filed: Apr. 15, 2024

Related U.S. Application Data
(60) Provisional application No. 63/567,517, filed on Mar. 20, 2024.

(51) Int. Cl. G01V 1/50; G01H 9/00; G01V 1/52

(52) U.S. Cl. CPC G01V 1/50; G01H 9/004; G01V 1/52

(57) ABSTRACT

Methods and systems for managing operation of a well are disclosed. The method may include obtaining distributed acoustic sensing (DAS) data based on a measurement made using a DAS sensing element positioned in the well. A qualification process for the DAS data may be performed to identify whether any portion of the DAS sensing element was acoustically coupled to a structure of the well during the measurement in a manner that introduced at least one artifact to the DAS data. If at least one portion of the DAS sensing element was coupled in such a manner, a remediation process may be performed to manage impacts of the at least one artifact on downstream use of the DAS data.

### CROSS-REFERENCE TO RELATED APPLICATIONS

This application is based on and claims priority to U.S. Provisional Application Ser. No. 63/567,517, filed Mar. 20, 2024, which is incorporated herein by reference in its entirety.

### FIELD

Embodiments disclosed herein relate generally to well operations. More particularly, embodiments disclosed herein relate to systems and methods for operating wells using distributed acoustic sensing data.

### BACKGROUND

Geological formations may host a range of resources. For example, geological formations may include trapped liquids and/or gasses that may include hydrocarbons of various types. These hydrocarbons may be used for a variety of purposes.

Well logging tools may be used to probe the geological formations penetrated by a wellbore in order to obtain information regarding geological formation properties and/or properties of the wellbore itself. This information may be used to produce the hydrocarbons.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an aspect, a method for managing operation of a well is disclosed. The method may include: obtaining distributed acoustic sensing (DAS) data, the DAS data being based on a measurement made using a DAS sensing element positioned in the well; and, performing a qualification process for the DAS data to identify whether any portion of the DAS sensing element was acoustically coupled to a structure of the well during the measurement in a manner that introduced at least one artifact to the DAS data.

In a first instance of the performing of the qualification process where at least one portion of the DAS sensing element was coupled to the structure in the manner that introduced the at least one artifact to the DAS data, the method may include performing a remediation process to manage impacts of the at least one artifact on downstream use of the DAS data.

Performing the qualification process may include: performing a clustering analysis using portions of the DAS data to establish a set of clusters of the portions of the DAS data; qualifying each cluster of the set of clusters with respect to whether the at least one artifact is present; and, qualifying portions of the DAS sensing element using corresponding clusters of the set of clusters with respect to whether each respective portion of the DAS sensing element is acoustically coupled to the structure in the manner that introduced the at least one artifact to the DAS data.

Performing the qualification process may further include performing a preconditioning process using the DAS data to obtain the portions of the DAS data, and each of the portions of the DAS data may include frequency domain data.

Qualifying each cluster of the set of clusters with respect to whether the at least one artifact is present may include matching frequency domain data from members of each cluster to a template of a set of templates, and each template of the set of templates indicating spectral responses associated with different acoustic coupling conditions for DAS sensing elements.

Performing the qualification process may include: obtaining a set of cross-correlation coefficients for portions of the DAS data; obtaining statistical characterizations of subsets of the set of cross-correlation coefficients; and, qualifying portions of the DAS sensing element using a corresponding statistical characterization of the statistical characterizations with respect to whether each respective portion of the DAS sensing element is acoustically coupled to the structure in the manner that introduced the at least one artifact to the DAS data.

Qualifying the portions of the DAS sensing element may include: obtaining a threshold for the statistical characterizations; and, for a portion of the portions of the DAS sensing element, comparing the corresponding statistical characterization to the threshold to ascertain whether the portion of the DAS sensing element is acoustically coupled to the structure in the manner that introduced the at least one artifact to the DAS data.

Performing the remediation process may include providing, to an operator of the well, information regarding the at least one portion of the DAS sensing element to facilitate supplementary measurements that are performed in a manner prescribed to manage acoustic coupling between the at least one portion of the DAS sensing element and the structure.

Performing the remediation process may include identifying, from the DAS data, qualified DAS data for use in modeling of the well.

Downstream use of the DAS data may include obtaining a well model for the well based, in part, on the DAS data, and selecting operating parameters for the well based, in part, on the well model, wherein the well is operated using the operating parameters.

Downstream use of the DAS data may also include: obtaining a geological model for a geological formation penetrated by the well based, in part, on the DAS data; and, obtaining an energy product based, in part, on the geological model.

In an aspect, a non-transitory machine-readable medium having instructions stored therein, which when executed by a processor, cause the processor to perform operations for managing operation of a well is disclosed. The operations may cause the method, as discussed above, to be performed.

In an aspect, a data processing system is provided. The data processing system may include a processor; and a memory coupled to the processor to store instructions, which when executed by the processor, cause the processor to perform operations for managing operation of a well. The operations may cause the method, as discussed above, to be performed.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a first system in accordance with an embodiment.

FIG. 1B shows a block diagram illustrating a second system in accordance with an embodiment.

FIGS. 2A-2E show data flow diagrams in accordance with an embodiment.

FIGS. 3A-3C show plots of data in accordance with an embodiment.

FIG. 4 shows a flow diagram illustrating a method in accordance with an embodiment.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

Exploitation of subterranean resources may allow for hydrocarbon-based fuels to be produced, gaseous hydrocarbon products to be generated, and/or for other energy products to be obtained. To exploit the subterranean resources, wells used to extract the subterranean resources may be created.

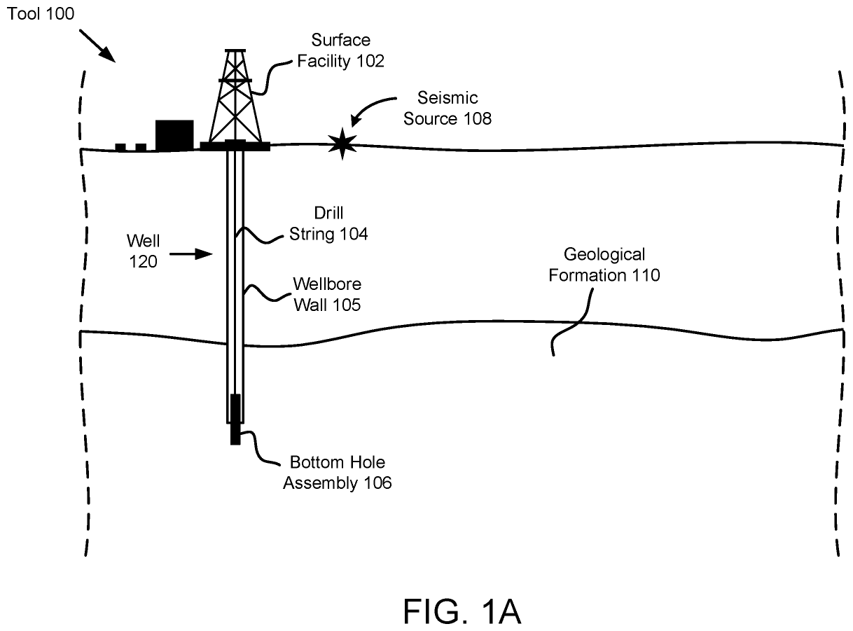

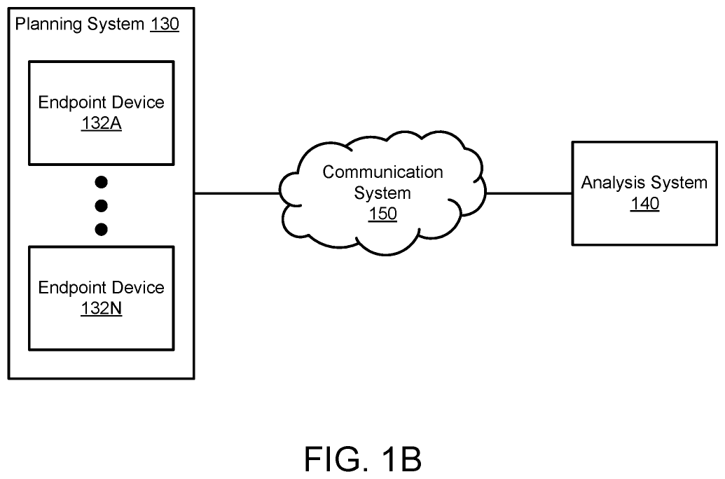

Turning to FIG. 1A, a first block diagram illustrating a first system in accordance with an embodiment is shown. The first system may be used to exploit geological formation 110. Geological formation 110 may be a portion of the earth crust. In the example shown in FIG. 1A, geological formation 110 is illustrated as being a layer positioned on land; however, it will be appreciated that embodiments disclosed herein may be used with respect to geological formations positioned below oceans or other bodies of water.

Geological formation 110 may be usable, for example, to produce energy resources (e.g., hydrocarbons), to sequester undesired materials (e.g., greenhouse gasses), and/or for other purposes. To exploit geological formation 110, well 120 may be drilled to provide for physical access to geological formation 110. In this manner, materials may be removed from and/or added to geological formation 110 (e.g., via well 120). Although shown as a vertical well in FIG. 1A, well 120 may be a directional well, a horizontal well, and/or any other type of well (e.g., having curved wellbore sections).

To determine how to exploit geological formation 110, information regarding the properties of geological formation 110 may be collected. To do so, tool 100 may be used. Tool 100 may include any of surface facility 102, drill string 104, bottom hole assembly 106, and/or other tools (e.g., logging tools, not shown).

Surface facility 102 may be a facility positioned above geological formation 110. While drawn in FIG. 1A as being positioned on land and including a derrick, surface facility 102 may be a waterborne vessel such as a drill ship or other type of sea going vessel (e.g., a platform) without departing from embodiments disclosed herein.

Surface facility 102 may include, for example, (i) control systems for other components, (ii) materials (e.g., drilling mud, water, gasses such as carbon dioxide) usable to form and characterize well 120 and/or geological formation 110, (iii) various assemblies and/or components usable with various assemblies, (iv) drill pipe and/or other components for well development, (v) completion components such as cement for completion of well 120, (vi) power systems, (vii) storage tanks for various materials used in well construction, and/or (viii) other materials, systems, etc. for well development.

Drill string 104 may include (i) any number of sections of drill pipe, (ii) wirelines usable to send control signals and/or power to downhole components, (iii) fluid lines and/or other lines for moving of fluids between bottom hole assembly 106 and/or surface facility 102 (e.g., while drilling well 120), and/or (iv) other components usable as part of a drill string. Drill string 104 may connect bottom hole assembly 106 to surface facility 102, and may divide the wellbore into an annulus (e.g., an area between the outside of the drill pipe and wellbore walls) and interior of tool 100.

Bottom hole assembly 106 may provide for, in addition to other functions, and/or performance of various tests on well 120 and/or portions of geological formation 110 surrounding (e.g., proximate to) well 120.

To obtain information regarding the properties of well 120 and/or geological formation 110, tool 100 may include various logging tools (not shown) that may collect and/or transmit measurement data, such as well log data and/or borehole seismic data (e.g., vertical seismic profile (VSP) data). For example, tool 100 may include a distributed acoustic sensing (DAS) system. The DAS system may be used in various well and/or reservoir monitoring applications such as production and injection profiling, leak detection (e.g., wells, pipelines), hydraulic fracture monitoring, flow assurance, and seismic acquisition (e.g., borehole seismic acquisition).

To acquire borehole seismic data, the DAS system may be activated from surface facility 102, which may facilitate data transmission from components of the DAS system. The DAS system may exploit properties of acoustic wave energy (e.g., seismic wave energy), which may induce oscillations within, interact with, and/or may be otherwise influenced by properties of geological formation 110.

For example, acoustic signals from seismic source 108 may be emitted into geological formation 110. Seismic source 108 may be positioned at various distances from well 120, and may include any type of device usable to generate controlled seismic energy, such as a seismic vibrator (e.g., a Vibroseis truck), explosions (e.g., dynamite, air guns), and/or other types of generators. The emitted seismic energy (e.g., acoustic signals) may be reflected from structural features of geological formation 110 before being detected using a sensing element located in well 120. For example, the sensing element may include a DAS sensing element, such as a fiber-optic cable. While illustrated as being positioned on a surface in FIG. 1A, it will be appreciated that seismic source 108 may be positioned elsewhere (e.g., sub-surface, in-well, etc.) without departing from embodiments disclosed herein.

The DAS sensing element (not shown) may be installed in well 120, and may be acoustically coupled to a structure of well 120 (e.g., wellbore wall 105). For example, the DAS sensing element may be cemented outside of casing of well 120 and/or in any other manner that provides for sensing acoustic signals emitted by seismic source 108. To record the acoustic signals (e.g., the reflections), the DAS sensing element may be connected to a DAS interrogator unit at the surface. The DAS interrogator (e.g., an optoelectronic instrument) may observe disturbances along the optical fiber, which may be caused by vibrations of (reflected) acoustic signals. The DAS interrogator unit may communicate with other equipment at the surface, such as a controller of seismic source 108, in order to manage source signals, source geometry, timestamps, etc.

The (reflected) acoustic signals may be recorded as DAS data (e.g., acoustic waveform data) over a period of time. The time series data recorded at different locations (e.g., every few meters) along the DAS sensing element may be referred to as traces, and reflections from the structural features may appear as coherent energy across adjacent traces (e.g., at different intervals along the DAS sensing element). The DAS data (e.g., the timing of reflections thereof) may provide data usable to infer structural properties of well 120 and/or geological formation 110. For example, the DAS data may be used to provide rock properties of geological formation 110 (e.g., via seismic velocity, impedance, anisotropy, attenuation, reflectivity), and to calibrate and/or interpret other data regarding geological formation 110 (e.g., seismic data, well log data).

For example, the DAS data, along with other data regarding geological formation 110 may be used to identify fracture properties (e.g., dip, azimuth), and/or to assess structural connectivity of portions of geological formation 110. However, the DAS data may be used to infer these properties with different degrees of accuracy depending on a variety factors and/or a set of assumptions that may or may not be true. For example, the quality of the recorded DAS data may impact its usability and/or trustworthiness in inferring these properties.

The quality of the recorded DAS data may be directly affected by coupling quality of the DAS sensing element (e.g., how well the DAS sensing element is coupled to the structure of the well). Adequate coupling of the DAS sensing element to (to the structure) may allow for recording of an acceptable level of signal to noise ratio DAS data (e.g., usable for reliably inferring properties of well 120 and/or geological formation 110, based on some quality standard). However, poor coupling of the DAS sensing element may be likely to introduce artifacts to the DAS data and/or otherwise negatively affect characteristics of the recorded signal (e.g., amplitude, phase, frequency content).

For example, the DAS sensing element may be poorly coupled when insufficient contact is made between the DAS sensing element and the structure (e.g., well casing and/or wellbore wall), or when the DAS sensing element is insufficiently fixed to the structure (e.g., allowing the DAS sensing element to move or vibrate). As a result, the recorded waveforms may be distorted, recorded amplitudes may be reduced, and/or ringing noise may be more pronounced.

Artifacts introduced by poor coupling of the DAS sensing element may include, for example, ringing noise, low amplitude data, and/or other types of noise (e.g., unwanted recorded acoustic energy). Therefore, poor coupling of the DAS sensing element may reduce the signal to noise ratio of the DAS data to a level of quality that may negatively impact downstream use of the DAS data. However, coupling quality of the DAS sensing element may not be known until DAS data has been acquired and evaluated (e.g., using qualitative judgement), which may result in acquisition of large volumes of poor-quality DAS data (e.g., unnecessary resource expenditure).

Thus, in order to obtain reliable information regarding the properties of geological formation 110 (and in other applications that may use DAS data), the DAS data may be analyzed and/or qualified (e.g., based on its artifact content) automatically and in real-time before being provided for downstream use. The qualified (e.g., reliable) DAS data, along with other data regarding well 120 and/or geological formation 110, may be trusted for use in improving well operations and planning.

For example, drilling and completion designs may be optimized via improved fracture evaluation, geological modeling, and/or reservoir evaluation. Thus, the qualified DAS data may be used to design an operation plan for well 120 that may be likely to increase hydrocarbon recovery and/or reduce the costs associated with hydrocarbon recovery. In addition, portions of DAS data may be qualified in real-time in order to characterize coupling of the DAS sensing element. By doing so, any identified coupling issues may be addressed in order to improve and/or ensure usability of subsequent portions of recorded DAS data. Therefore, the manner in which the DAS data is qualified (e.g., the reliability of the DAS data, the ability to qualify portions of DAS data in real-time) may impact a rate of hydrocarbon production using the well.

In general, embodiments disclosed herein relate to methods and systems for operating wells, obtaining information to aid in the modeling of wells, and/or proximate geological formations for various uses. To manage operation of the wells and to provide additional information regarding the wells (e.g., properties of the geological formation), after wellbores are drilled, various intervals along the wellbore of the well and/or corresponding proximate portions of geological formation may be characterized using well logging techniques (e.g., borehole seismic data acquired using a DAS sensing element in a well) to obtain DAS data and/or other information.

The DAS data and/or other information may be processed (e.g., integrated) in order to infer rock and/or structural properties of the geological formation surrounding the well that may, in some combination, indicate a likelihood of a presence of hydrocarbons, a likelihood of facilitating recovery of hydrocarbons, and/or other information relating to safe and cost-effective energy production via the well.

To increase the likelihood of operating the well in a manner that may effectively exploit subterranean resources, the DAS data obtained via the borehole seismic survey may undergo a series of processing and analysis in order to qualify the DAS data. The processing and analysis may include automatic and/or quantitative evaluation methods for the DAS data (e.g., and coupling quality) in order to identify qualified DAS data that may be reliable for downstream use.

The processing and analysis may include, for example, (i) data conditioning (e.g., pre-processing) of the DAS data to obtain conditioned DAS data (e.g., frequency domain DAS data) for further analysis, (ii) performing a qualification process for the conditioned DAS data to obtain qualified DAS data and/or unqualified DAS data, (iii) using the unqualified DAS data (e.g., DAS data with) to perform a remediation process to manage impacts of the DAS data on downstream use, (iv) using the qualified DAS data to infer properties of portions of the wellbore and/or the proximate geological formation, and/or (v) using the properties to guide operation of the well to facilitate the exploitation of the subterranean resources.

By analyzing the DAS data in the frequency domain, distinct signatures of artifacts (e.g., waveform distortion, ringing) that may be introduced to the DAS data due to poorly coupled sections of the DAS sensing element may be revealed, and other types of noise may be identified (e.g., surface noise). For example, frequency spectra of the DAS data may exhibit different characteristics (e.g., due to differing amplitudes and/or dominant frequencies) based on its artifact content; therefore, poorly coupled section of the DAS sensing element may exhibit different characteristics than adequately coupled sections of the DAS sensing element. These differences may be exploited during the qualification process to characterize coupling quality of the DAS sensing element, and to identify DAS data that may be reliable for downstream use (e.g., qualified DAS data).

The qualification process may include performing a coherency analysis process (based on pair-wise cross correlation values in the frequency domain) and/or a cluster analysis process (based on characteristics of frequency spectra of DAS data) in order to discriminate between qualified DAS data and unqualified DAS data.

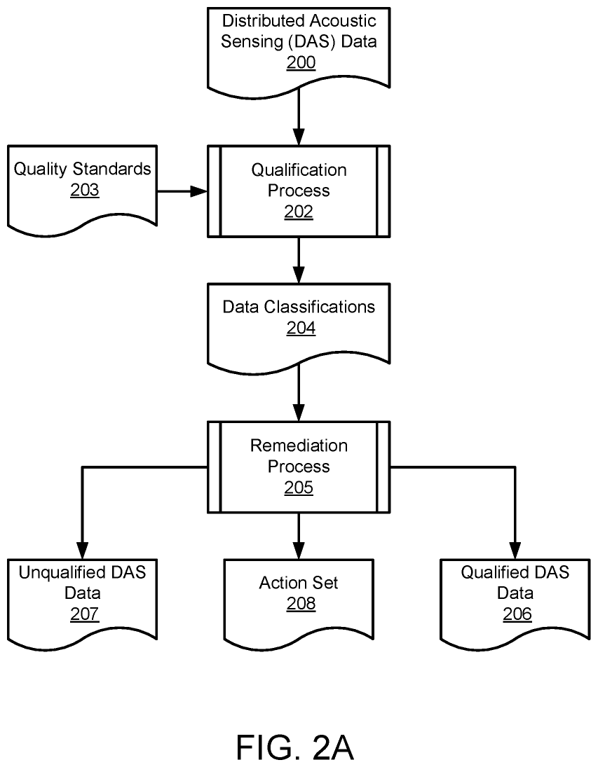

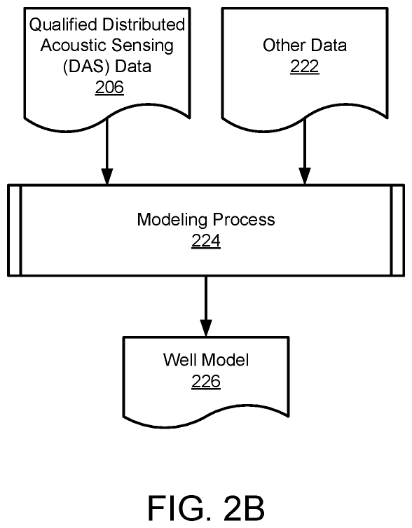

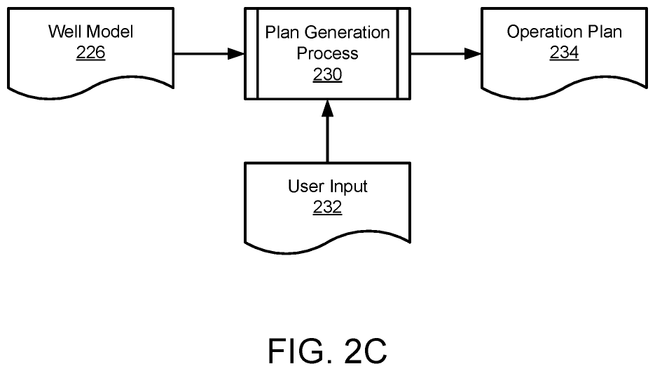

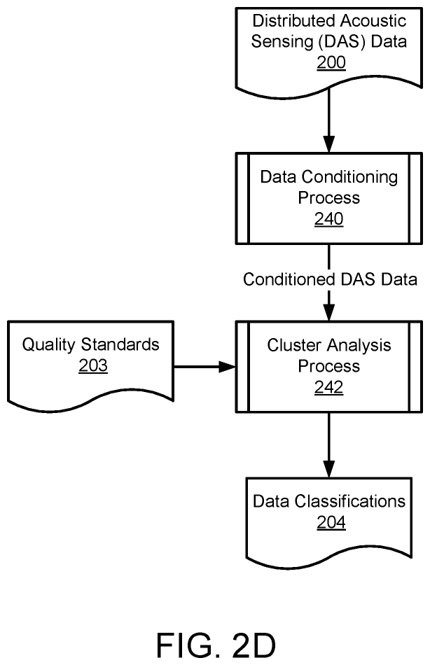

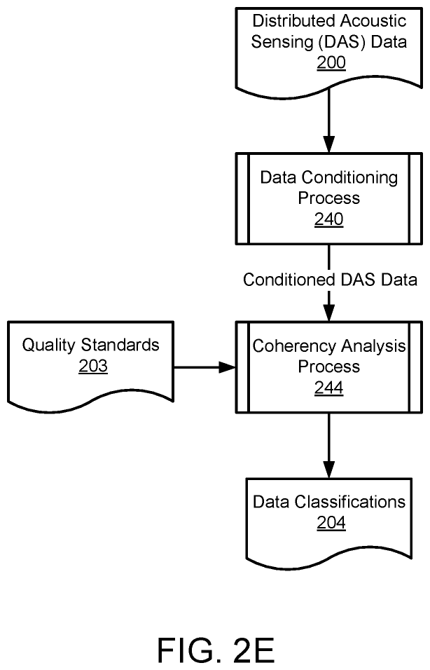

The unqualified DAS data may include portions of DAS data (e.g., traces) with low signal to noise ratios due to artifact content, while the qualified DAS data may include portions of DAS data with high signal to noise ratios due to lack of artifact content. Therefore, the unqualified DAS data may correspond to portions (e.g., intervals, sections) of the DAS sensing element that may be coupled in a manner likely to introduce artifacts to the DAS data. For more information regarding data conditioning and qualification processes, refer to the discussion of FIGS. 2D-2E.

The remediation process may be performed, for example, in order to resolve cable coupling issues (e.g., to improve subsequent data quality), to pause DAS acquisition (e.g., to reduce costs), and/or to provide only qualified DAS data for downstream use. For more information regarding remediation processes, refer to the discussion of FIG. 2A.

By doing so, qualified DAS data may be more likely to be available due to improvements in recorded DAS data quality, which may result in improved estimation of formation properties. The formation properties may be used in combination with other data to obtain a well model (e.g., a geological model), which may be used to establish an operation plan (e.g., well completion plans and/or any other type of plan for exploitation of the geological formation).

Operation plans may be obtained in an automated (e.g., computer defined), semiautomated (e.g., computer guided with subject matter expert review/feedback), and/or manual (e.g., subject matter expert defined) manner. Once obtained, wells may then be operated (e.g., completed, and the geological formation may then be exploited) according to the plans. Thus, the resulting wells and corresponding exploitation of the geological formation may be more likely to be desirable by virtue of the accuracy of the formation properties used in the formulation of the operation plans. To obtain operation plans, a modeling system in accordance with an embodiment may be used. Refer to the discussion of FIGS. 2B-2C for more information regarding well modeling and/or operation planning.

Although described herein with respect to oil and gas industry applications, a DAS system may be used for other purposes, such as in disaster monitoring and mitigation (e.g., recording acoustic signals caused by earthquakes, volcanoes, and/or storms), engineering applications (e.g., civil engineering for structural monitoring, traffic monitoring), etc.

Turning to FIG. 1B, a second block diagram illustrating a second system in accordance with an embodiment is shown. The second system may be used to establish operation plans for wells. To provide the above noted functionality, the modeling system of FIG. 1B may include planning system 130, analysis system 140, and communication system 150. Each of these components is discussed below.

Planning system 130 may facilitate operation planning for wells. To do so, planning system 130 may gather and provide information regarding a not-yet-completed well to analysis system 140. The information may have been obtained using a variety of downhole tools such as a micro-imager (e.g., measures resistivity along the wellbore), sonic tools (e.g., acoustic, or other sounds-based measurements), spectroscopic tools (e.g., measurements based on nuclear properties), and/or other types of downhole tools. For example, the information may include information from processed borehole seismic data (e.g., DAS data) and/or other data (e.g., seismic data, well log data).

Based on the provided data, analysis system 140 may return well properties, including (i) properties of the rock forming the geological formation in which the wellbore is positioned, (ii) properties of wellbore casing and/or cement (e.g., for evaluation of cement placement and/or quality), and/or (iii) other well properties. Planning system 130 may use this information to define an operation plan, and/or manage operation of a well based on the operation plan.

For example, planning system 130 may use the well properties and/or other information to define a topology of the well. The topology may be defined in an automated manner (e.g., automatic selection of where the well will interact with the geological formation), semi-automated (e.g., suggest where the well will interact with the geological formation, allow a subject matter expert to confirm/reject/modify the suggestion), and/or manual manner (e.g., allow the subject matter expert to review and use the information to define the operation plan.

To provide its functionality, planning system 130 may include any number of endpoint devices (e.g., 132A-132N). The endpoint devices may include various types of computing devices used by personnel working on operation of the wells.

Analysis system 140 may analyze the data provided by planning system 130 to identify rock properties and/or other information (e.g., zones of interest of the geological formation and/or along the wellbore). Once obtained, the rock properties may be used to obtain various graphical user interfaces (and/or other types of interfaces) usable by automated systems and/or subject matter experts to identify more promising locations along a wellbore with respect to hydrocarbon production. The graphical user interfaces and/or underlying data may be provided to planning system 130. Refer to FIGS. 2A-2E for additional details regarding information provided by analysis system 140 to planning system 130.

When providing their functionality, any of (and/or components thereof) planning system 130 and analysis system 140 may perform all, or a portion, of the actions and methods illustrated in FIGS. 2A-4.

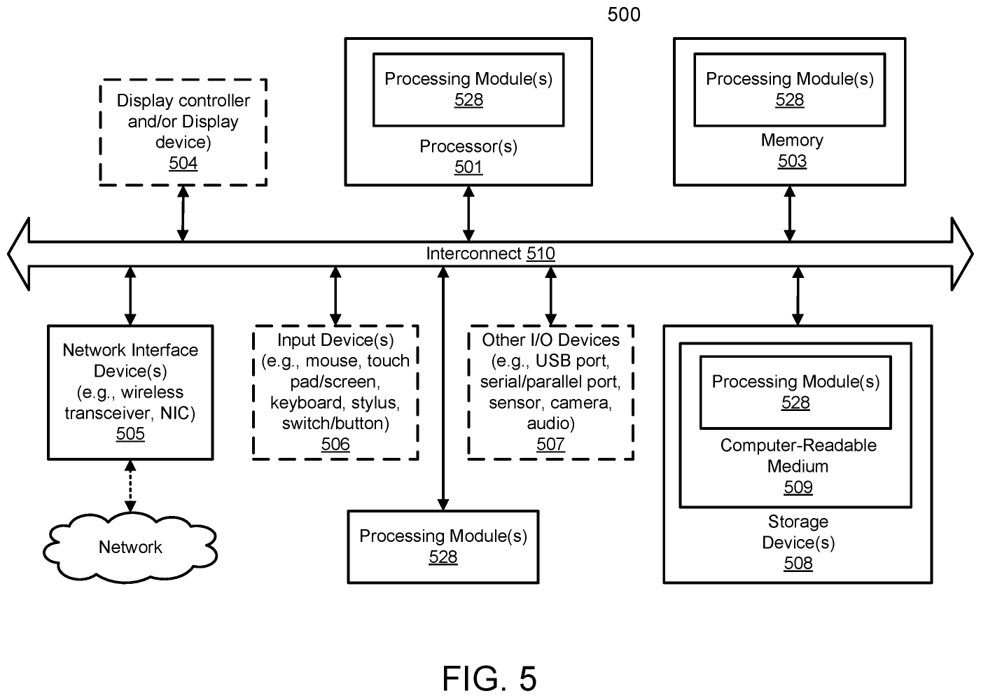

Any of (and/or components thereof) planning system 130 and analysis system 140 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 5.

Any of the components illustrated in FIG. 1B may be operably connected to each other (and/or components not illustrated) with communication system 150. In an embodiment, communication system 150 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1B as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2E. In these diagrams, flows of data and processing of data are illustrated using different sets of shapes. A first set of shapes (e.g., 200, 204, etc.) is used to represent data structures, and a second set of shapes (e.g., 202, 205, etc.) is used to represent processes performed using and/or that generate data. Additionally, as part of the flows of data, various data processing operations may be performed.

Turning to FIG. 2A, a first data flow diagram in accordance with an embodiment is shown. The first data flow diagram may illustrate data used in and data processing performed in preparing DAS data for well modeling.

To prepare DAS data for modeling, qualification process 202 may be performed using DAS data 200. DAS data 200 may include measurements made by a DAS sensing element positioned in a well. Each measurement may be a continuous or discrete characterization of the portions of the well and/or the geological formation surrounding the well.

For example, to obtain DAS data 200, a seismic source may be excited at or near the surface, some distance(s) from the well. Acoustic signals emitted from the excited seismic source may interact with structure of the geological formation (e.g., acoustic signals may be reflected by, refracted by, transmitted through and/or absorbed by layers of the geological formation) before interacting with the DAS sensing element. The DAS sensing element may transmit measurements based on its interaction with acoustic signals (and other energy that may be considered noise traveling through layers of the geological formation) to a recording device. The recorded measurements may be included as part of DAS data 200, along with other information such as source signal information, geometry information, etc.

Qualification process 202 may be performed in order to identify whether any portion of the DAS sensing element was poorly coupled (e.g., acoustically coupled to a structure of the well during acquisition of DAS data 200 in a manner that may have introduced at least one artifact to the DAS data). For example, poor coupling in sections of the DAS sensing element may be indicated by decreased waveform amplitudes, distorted waveform phases, and/or strong ringing noise.

Reduced waveform amplitude may result from insufficient contact and/or fixation between the DAS sensing element and the well casing. The reduced waveform amplitudes may not accurately reflect the true motion of the surrounded stimulated medium (e.g., the geological formation). Distorted waveform phases and/or ringing noise may also be consequences of poor coupling, and may be more severe when the DAS sensing element vibrates (e.g., generating strong and periodic noise). While these effects may be visually identified in recorded DAS data, manual inspection (e.g., by a subject matter expert) at field sites may be unavailable and/or limited; therefore, automatic methods of identifying poor coupling during acquisition of DAS data may be implemented during qualification process 202.

During qualification process 202, (i) artifacts included in DAS data 200 may be identified (e.g., statistical outliers), (ii) data classifications (e.g., 204) for portions of DAS data 200 may be obtained based on identified artifacts, (iii) relevant information for inferring formation properties may be extracted (e.g., from DAS data 200), and/or (iv) DAS data 200 may be placed in a form for subsequent modeling. For example, the resulting qualified DAS data 206 may be compatible with various analysis algorithms, well modeling processes, and/or other processes.

To identify artifacts, criteria and/or other information from quality standards 203 may be provided to qualification process 202. For example, quality standards 203 may include various criteria (e.g., different types of thresholds) associated with various data classifications for DAS data 200. Quality standards 203 may be used to differentiate good quality (e.g., high signal to noise ratio) DAS data and low quality (e.g., low signal to noise ratio) DAS data, and therefore may be used to classify portions of DAS data 200 accordingly. During qualification process 202, data classifications 204 may be obtained using methods discussed with respect to FIGS. 2D-2E and/or by other methods.

Data classifications 204 may include information that indicates associations between (i) portions of (e.g., traces of) DAS data 200, (ii) portions of (e.g., sections of) the DAS sensing element, (iii) data classifications (e.g., data quality scores and/or other statistics derived based on DAS data 200). For example, the data classifications may indicate a group of traces of DAS data 200 that are associated with a section of the DAS sensing element, and whether the group of traces fails to meet criteria from quality standards 203 (e.g., a coupling quality map for the DAS sensing element). Therefore, information included in data classifications 204 may be used to identify portions of the DAS sensing element that are likely to be poorly coupled.

To identify instances of poor coupling of the DAS sensing element, remediation process 205 may be performed. During remediation process 205, the data classifications may be used to (i) obtain qualified DAS data 206 and/or unqualified DAS data 207 (e.g., from DAS data 200), (ii) qualify portions of the DAS sensing element with respect to whether each of the portions were adequately (e.g., based on quality standards 203) acoustically coupled during acquisition of the respective portion of DAS data 200, and/or (iii) obtain an action set for remediating impacts of poor acoustic coupling based on the qualified portions of the DAS sensing element.

Action set 208 may include actions such as (i) providing qualified DAS data 206 for use in modeling of the well and/or the geological formation, (ii) providing information regarding qualified DAS data 206 and/or unqualified DAS data 207 to another entity (e.g., a field operator) and/or (iii) other actions. For example, qualified DAS data 206 may include portions of DAS data 200 that are trusted and/or reliable for downstream use (e.g., according to quality standards 203).

Other entities may use the information regarding qualified DAS data 206 and/or unqualified DAS data 207 to (i) adjust DAS acquisition in real-time (e.g., proactive modification of cable tension or cable slack based on the coupling qualify map for the DAS sensing element) in order to improve coupling (and therefore the signal to noise ratio of the subsequently acquired DAS data), (ii) update best practices (e.g., quality standards 203, DAS deployment strategies), and/or (iii) improve understanding of physics underlying DAS decoupling thereby guiding future calibration efforts. By doing so, resources used in data processing of subsequently acquired DAS data and/or costs of unnecessary data acquisition and storage may be reduced.

Once obtained, qualified DAS data 206 may be used to guide operation of the well. For example, qualified DAS data 206 may be used to infer well conditions and/or characteristics of the geological formation surrounding the well. This information may be used to decide how to operate the well, such as where to install completion components such as chokes, packers, perforations, and/or other types of components that may be used to modify a manner in which the well operates. Refer to FIGS. 2B-2C for more information regarding use of qualified DAS data 206 in well operation.

Turning to FIG. 2B, a second data flow diagram in accordance with an embodiment is shown. The second data flow diagram may illustrate data used in and data processing performed in obtaining a well model usable to guide operation of a well.

To obtain well model 226, modeling process 224 may be performed. During modeling process 224, qualified DAS data 206 and other data 222 may be ingested and used to generate well model 226. Qualified DAS data 206 and other data 222 may include information regarding different types of measurements of the well and/or the geological formation. For example, features such as geological boundaries, faults, layering, and/or fractures may be identified based on waveforms of qualified DAS data 206.

For example, qualified DAS data 206 may include processed seismic data and/or information derived from qualified DAS data 206 (e.g., seismic attributes and/or rock properties relevant to various portions of the geological formation). Other data 222 may include, for example, other seismic data, well log data, core analysis data, fracture data, historical production information (e.g., for other proximate wells), and/or any other data usable for well modeling, geological modeling, etc.

During modeling process 224, well properties (including properties of the geological formation) may be inferred based on the ingest data. For example, qualified DAS data 206 and/or other data 222 may be used to infer a structural framework of a geological model of the formation, rock properties and/or types included in the geological formation, information usable to characterize the topology of the well, etc.

The resulting well model 226 may include a model of the well and/or a geological model of the geological formation proximate to the well. Well model 226 may include any number of well models. For example, when information regarding multiple wells (and proximate geological formations) situated in a field are input to modeling process 224, well model 226 may include a geological model of the field. Well model 226 may be used as a static model as input to a reservoir simulation process and/or to obtain a well operation plan.

Turning to FIG. 2C, a third data flow diagram in accordance with an embodiment is shown. The third data flow diagram may illustrate data used in and data processing performed in obtaining an operation plan usable to operate a well.

To obtain operation plan 234, plan generation process 230 may be performed. During plan generation process 230, well model 226 may be analyzed to identify portions of the geological formation that are composed of materials that may facilitate energy production via the well. Portions of the wellbore corresponding to the identified portions of the geological formation may also be identified and may be used to generate operation plan 234. A user may provide user input 232, which may include values for various criteria and/or other information that may influence the outcome of plan generation process 230 (e.g., operation plan 234).

Operation plan 234 may include any number of parameters for operating the well and/or actions to be performed in order to operate the well. For example, operation plan 234 may include completion plans and/or drilling plans (e.g., for well deviations).

Once obtained, operation plan 234 may be used to operate (e.g., complete) a well. For example, all or a portion of the actions specified by operation plan 234 may be performed to operate the well. The operation plan may include a well completion plan. An operator of the planning system may use the well model to complete the well completion plan. For example, a subject matter expert, another person, or an automated system may use the well model to identify portions of the well for hydrocarbon exploitation. The identified portions may be used to define workflows (e.g., actions) to complete the well such that the portions of the well are used for the eventual exploitation of hydrocarbons. For example, various portions of the well may be designated for perforating.

The well may be completed using the operation plan to obtain a completed well. The well may be completed by performing any of the actions/workflows specified by the operation plan. For example, various actions may be performed to install completion components in the well. The location and type of the completion components may be based on the well model. Once completed, the well may be used, for example to bring various types of hydrocarbons to the surface. It will be appreciated that the well may be used for other purposes without departing from embodiments disclosed herein.

As previously discussed, DAS data may be used to operate wells. FIGS. 2D-2E show example processing flows usable to obtain data classifications in order to identify qualified DAS data that may be trusted for use in well operations. However, it will be appreciated that the processing steps of the example processing flows may be performed in different orders (e.g., sequentially or in parallel), any may be omitted, and other may be performed without departing from embodiments disclosed herein.

Turning to FIG. 2D, a fourth data flow diagram in accordance with an embodiment is shown. The fourth data flow diagram may illustrate a first example of data used in and data processing performed in order to obtain data classifications for DAS data acquired for a well (e.g., for a geological formation in which the well is positioned). FIG. 2D may show a first example of qualification process 202 of FIG. 2A.

To obtain the data classifications (e.g., 204), DAS data 200 may be provided to preconditioning process (e.g., data conditioning process 240). DAS data 200 may include time domain data (e.g., time series data, traces) recorded at various locations (e.g., depths) along a DAS sensing element positioned in the well.

During data conditioning process 240, various processes (e.g., calibration, wavefield separation, geometry loading, frequency filtering, signal enhancement, domain transform) that may improve signal-to-noise ratios of DAS data 200 and/or that may otherwise prepare (e.g., manipulate) DAS data 200 for analysis or interpretation may be performed in order to obtain conditioned DAS data.

For example, DAS data 200 may undergo a filtering process to isolate a frequency range of interest (e.g., using a band-pass filter, based on acquisition parameters of DAS data 200). The filtered data may be windowed (e.g., that correspond to the timing of the recorded acoustic signal) and may be transformed to the frequency domain using a Fourier transformation and/or other type of transformation algorithm. During data conditioning process 240, frequency domain data may be obtained based on DAS data 200.

For example, the conditioned DAS data obtained during data conditioning process 240 may include frequency spectra (e.g., amplitude spectra) of portions of DAS data 200. The conditioned data may be analyzed during cluster analysis process 242 in order to obtain data classifications 204. Any portions of or all of data conditioning process 240 may be optional depending on data requirements for cluster analysis process 242.

During cluster analysis process 242, the conditioned DAS data may be used to establish a set of clusters, and each cluster of the set of clusters may be qualified with respect to whether an artifact may be present in DAS data 200. When an artifact is present in DAS data 200, sections of the DAS sensing element may be qualified with respect to whether any of the sections were poorly coupled during acquisition of DAS data 200.

To establish the set of clusters, a clustering algorithm may be performed using the conditioned DAS data. Cluster analysis process 242 may be data-driven, and therefore a desired number of clusters output from the clustering process may be specified (e.g., by a user or another entity), and/or a number of clusters may be dynamically identified based on analysis of input data provided to cluster analysis process 242 (e.g., DAS data 200). For example, cluster analysis process 242 may include a K-shape clustering algorithm that identifies shape-based similarities of amplitude spectra while managing waveform distortions in amplitude and phase. Thus, the clustering algorithm may compare characteristics (e.g., shapes) of amplitude spectra of traces of DAS data 200 and group portions of DAS data 200 by their characteristics in order to establish the set of clusters.

The clustering algorithm may be configurable to enable a particular number of clusters to be established, to identify a desirable number of clusters to be established based on the input data (e.g., DAS data 200), and/or may otherwise be configurable to enable classification of frequency spectra without having foreknowledge of the numbers and types of clusters to be established.

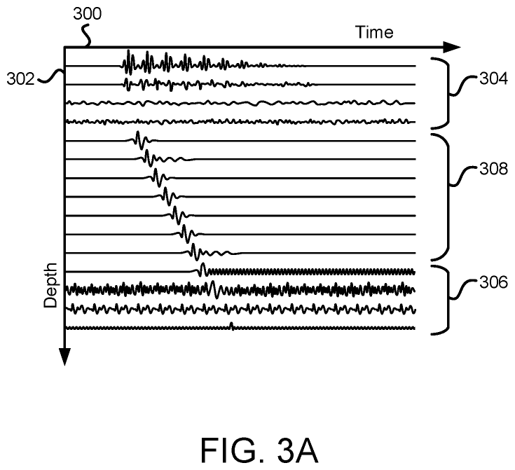

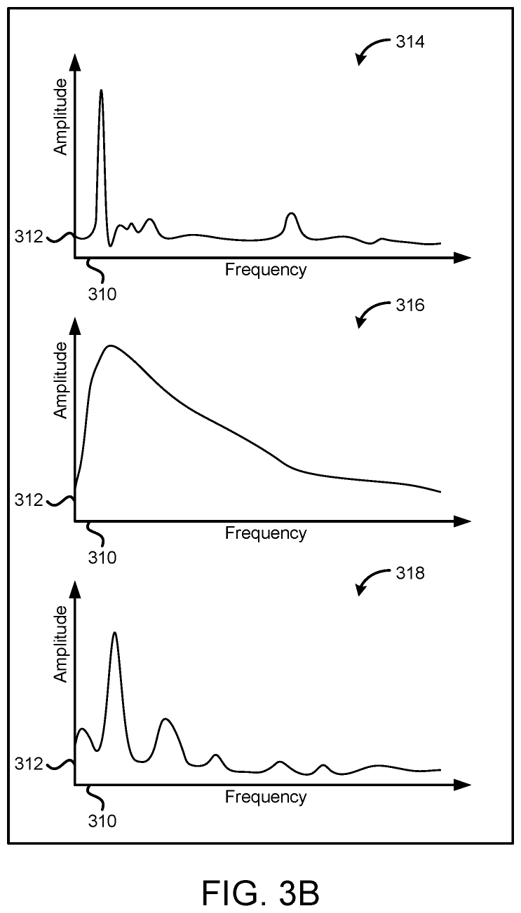

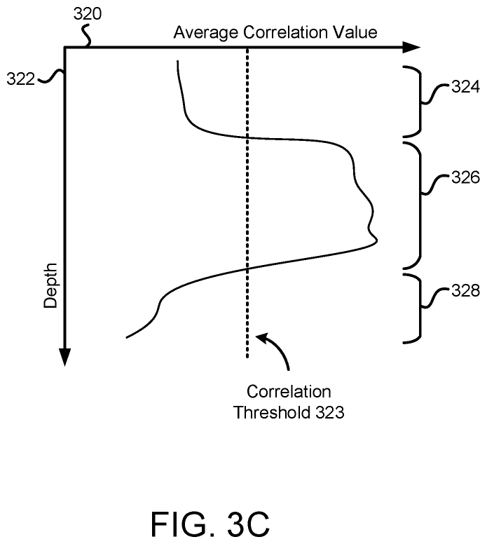

To qualify each cluster of the set of clusters with respect to whether an artifact may be present in DAS data 200, each cluster may be compared to a set of templates (e.g., from a template repository, not shown). Each template of the set of templates may indicate spectral responses associated with different artifact types and/or different acoustic coupling conditions for DAS sensing elements. For example, a spectral shape (e.g., within a shape tolerance) may be associated with ringing noise, which may be associated with loose coupling which may allow the DAS sensing element to vibrate, which may enhance the severity of the ringing noise. Data examples relating to cluster analysis process 242 are provided in FIGS. 3A-3B.

Turning to FIG. 3A, a first plot of data is shown in accordance with an embodiment. The first data plot may include an example of DAS data (e.g., 200) as it may be analyzed during a qualification process (e.g., 202). It will be appreciated that the data used in the creation of the data plots included herein is merely illustrative and that in practice, the data may be different than as illustrated in FIGS. 3A-3C.

In the first data plot, example waveforms of time series DAS data are shown. A horizontal axis may indicate a first dimension (e.g., time), increasing in the direction of arrow 300. A vertical axis may indicate a second dimension (e.g., depth, position on the DAS sensing element) of the DAS data, increasing in the direction of arrow 302. The plot shown illustrates three example groups of traces of the DAS data (e.g., 304, 306, 308).

For example, group 304 may include a first set of traces affected by surface and/or random noise, group 306 may include a second set of traces affected by strong ringing noise, and group 308 may include a third set of traces not affected by artifacts. In other words, group 308 may include high signal to noise ratio DAS data, desirable for downstream use, whereas group 304 and 306 may include low signal to noise ratio DAS data, which may negatively impact its downstream use.

To qualify the DAS data plotted in FIG. 3A, the DAS data may be transformed to the frequency domain and input to a clustering algorithm. An example of frequency domain DAS data is shown in FIG. 3B.

Turning to FIG. 3B, a second plot of data is shown in accordance with an embodiment. The second data plot may include an example of amplitude spectra of DAS data (e.g., 200) as a result of a clustering process performed using frequency domain DAS data.

In the second data plot, example amplitude spectra of DAS data are shown in each of spectral plots 314, 316, and 318. A horizontal axis may indicate frequency, increasing in the direction of arrow 310, and a vertical axis may indicate amplitude, increasing in the direction of arrow 312. In the example shown, the number of clusters specified for a (K-shape) clustering algorithm is three, in order to identify portions of the DAS data affected by surface noise, ringing noise, and signal.

Each of spectral plots 314, 316, and 318 show cluster centroids of the amplitude spectra of the clustered DAS data. The shapes of the spectral plots may be inspected manually (e.g., visually, by a subject matter expert), and/or automatically (e.g., using spectra templates from a template repository, not shown) to determine associations of the spectral shape and artifact content (e.g., to infer coupling quality).

For example, the shape of spectral plot 314 may be associated with surface and/or random noise, which may indicate that data contributing to spectral plot 314 (e.g., traces of group 304 of FIG. 3A) may include poor quality (e.g., low signal to noise) data, which may not be qualified for downstream use based on some data quality standard. Similarly, for example, the shape of spectral plot 318 may be associated with ringing noise (characterized by a number of spikes in the amplitude spectrum), which may indicate that data contributing to spectral plot 318 (e.g., traces of group 304 of FIG. 3B) were acquired at poorly coupled locations along the DAS sensing element.

The shape of spectral plot 316 may be associated with good signal (e.g., high signal to noise ratio DAS data), which may indicate that data contributing to spectral plot 316 (e.g., traces of group 308 of FIG. 3A) were acquired at adequately coupled locations along the DAS sensing element.

Returning to the discussion of FIG. 2D, during cluster analysis process 242 quality standards 203 may be used to qualify portions of DAS data 200 (e.g., based on the clustered amplitude spectra). For example, quality standards 203 may provide thresholds of tolerance (e.g., statistical metrics, shape tolerances) for classifying portions of DAS data 200 as qualified or unqualified. Thus, during cluster analysis process 242, data classifications 204 may be obtained. Refer to the discussion of FIG. 2A for more information regarding data classifications and their use in identifying portions of the DAS sensing element that may be poorly coupled.

Thus, using the data flow of FIG. 2D, a cluster analysis method may be implemented to facilitate an automatic and explorative data-driven approach to classifying (e.g., qualifying) DAS data. By doing so, DAS data quality and DAS sensing element coupling quality may be assessed in real-time (e.g., as DAS data is collected) with reduced need for human interaction in order to facilitate informed decisions regarding field deployment. In addition, the cluster analysis method may offer an investigative approach for understanding new characteristics of the DAS data.

Turning to FIG. 2E, a fifth data flow diagram in accordance with an embodiment is shown. The fifth data flow diagram may illustrate a second example of data used in and data processing performed in order to obtain qualified DAS data for a well (e.g., for a geological formation in which the well is positioned). FIG. 2D may show a second example of qualification process 202 of FIG. 2A.

To obtain the data classifications (e.g., 204), DAS data 200 may be provided to data conditioning process 240, where DAS data 200 may be preconditioned in a manner similar to that described with respect to FIG. 2D. The conditioned data obtained from data conditioning process 240 may be analyzed during coherency analysis process 244 in order to obtain data classifications 204.

During coherency analysis process 244, a measure of similarity of portions of the conditioned DAS data may be obtained using cross-correlation. For example, neighboring traces (e.g., adjacent amplitude spectra) of the conditioned DAS data may be cross-correlated to obtain a set of cross-correlation coefficients based on a number of neighboring traces to cross-correlate, N_{T}.

The number of neighboring traces may be based on a correlation distance along the well's trajectory. For example, when N_{T}=1, the cross-correlation coefficient may be computed between each pair of adjacent traces. Smaller values of N_{T} may be effective for identifying changes in signal coherency and phase distortions; however, smaller values of N_{T} may not be effective for identifying noise that may be continuous across multiple adjacent traces, such as ringing noise.

Or, for example, N_{T}=n, where n is the total number of traces in the DAS data record (e.g., the total number of locations along the DAS sensing element that recorded acoustic signal). In this case, the cross-correlation coefficient may be computed for every trace pair, resulting in a comprehensive similarity matrix (e.g., the set of cross-correlation coefficients). However, large values of N_{T} may be computationally demanding and/or may include comparisons between traces (e.g., first and last traces of the DAS data record) that may not offer insight into coupling quality.

Therefore, cross-correlation coefficients on the diagonal of the similarity matrix may be considered for further analysis. For example, 1<N_{T}<n may be some value based on a number of adjacent traces predicted to have ringing characteristics (e.g., based on historical analysis of DAS data) and/or other (predicted) data characteristics in order to define the diagonal of the similarity matrix. The parameters specified for coherency analysis process 244 (e.g., N_{T} and/or other parameters) may be tuned (e.g., modified, iteratively) throughout coherency analysis process 244 based on visual inspection of intermediate results.

To qualify portions of DAS data 200 (and/or portions of the DAS sensing element), a statistical characterization of subsets of the set of cross-correlation coefficients may be obtained. For example, cross-correlation coefficients on the diagonal of the similarity matrix may be averaged for each trace to obtain average correlation values. The average correlation values may be compared to a threshold to ascertain whether portions of the DAS data may be contaminated by artifacts, and therefore whether portions of the DAS sensing element were poorly coupled during acquisition of DAS data 200. A data example of average correlation values is provided in FIG. 3C.

Turning to FIG. 3C, a third plot of data is shown in accordance with an embodiment. The third data plot may include an example of data obtained and/or analyzed during a coherency analysis process for DAS data (e.g., 200).

In the third data plot, example cross-correlation coefficients obtained from frequency domain DAS data are shown. A horizontal axis may indicate an average correlation value, increasing in the direction of arrow 320, and may range from 0 to 1. A vertical axis may indicate a depth (e.g., position on the DAS sensing element) of the DAS data, increasing in the direction of arrow 322.

In the example shown, a dashed line indicating correlation threshold 323 delineates portions of a plot of average correlation values by depth (e.g., locations on the DAS sensing element). For example: portion 324 may correspond to portions of DAS data contaminated with surface and/or random noise traces, such as group 306 of FIG. 3A; portion 326 may correspond to portions of high signal to noise ratio DAS data, such as group 308 of FIG. 3A; and, portion 328 may correspond to portions of DAS data contaminated with strong ringing noise, such as group 306 of FIG. 3A.

Thus, portions of the DAS data associated with averaged cross-correlation values left of the dotted line (e.g., inferior to correlation threshold 323) may be considered low signal to noise ratio and/or unqualified DAS data, whereas portions of the DAS data associated with averaged cross-correlation values right of the dotted line (e.g., not inferior to correlation threshold 323) may be considered high signal to noise ratio and/or qualified DAS data.

Returning to the discussion of FIG. 2E, during coherency analysis process 244, quality standards 203 may be used to qualify portions of DAS data 200 based on a statistical characterization of cross-correlation coefficients of amplitude spectra of DAS data 200 (e.g., average correlation values for portions of DAS data 200). For example, quality standards 203 may provide correlation thresholds for classifying portions of DAS data 200 as qualified or unqualified. Thus, during coherency analysis process 244, data classifications 204 may be obtained. Refer to the discussion of FIG. 2A for more information regarding data classifications and their use in identifying portions of the DAS sensing element that may be poorly coupled.

Thus, using the data flow of FIG. 2E, a coherency analysis method may be implemented to facilitate a quantitative approach for classifying (e.g., qualifying) DAS data. By doing so, subject matter experts (e.g., field operators, geophysicists) may assess coupling quality of DAS sensing elements using a flexible (e.g., parameterizable) physics-based method.

Any of the data flows shown in FIGS. 2A-2E may be performed. For example, the fourth and fifth data flows (e.g., of FIGS. 2D and 2E) may be performed independently and/or in some combination in order to obtain data classifications (e.g., 204) for DAS data. For example, by using a clustering algorithm, qualification of portions of the DAS sensing element (e.g., especially those affected by strong ringing noise) may be automated, and by analyzing coherency of the DAS data, portions of the DAS sensing element that may be affected by phase distortion may be identified in a qualitative manner.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using the data flows shown in FIGS. 2A-2E, acoustic signal reflections recorded by a DAS sensing element may be qualified automatically and/or in real-time in a manner that may improve the quality and/or reliability of DAS data recorded in the field and/or used in subsequent well modeling and planning processes. Doing so may improve the reliability and effectiveness of well operation plans generated using the DAS data.

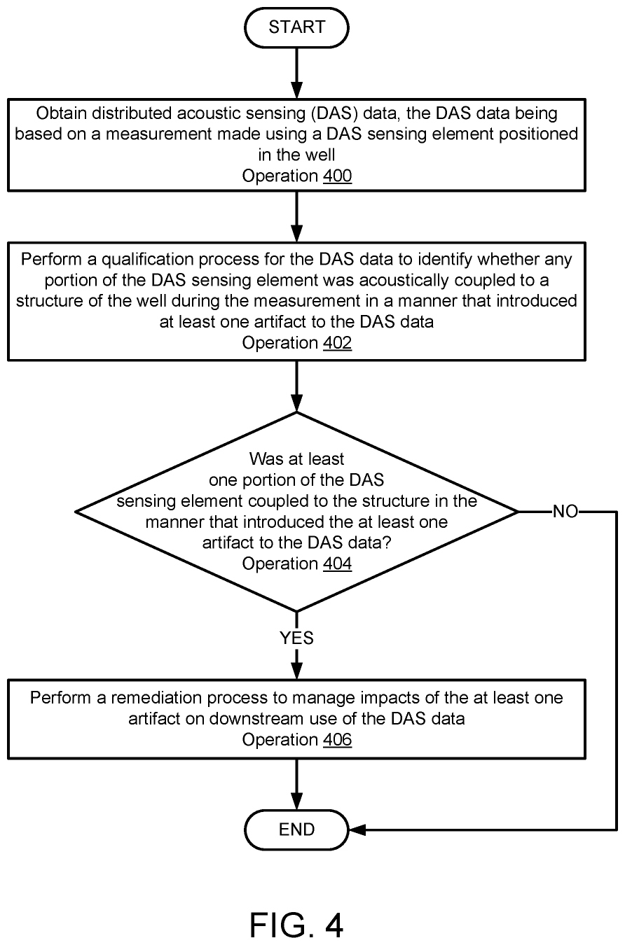

Turning to FIG. 4, a flow diagram illustrating a method in accordance with an embodiment is shown. The flow diagram may illustrate various operations performed while managing operation of a well.

At operation 400, DAS data may be obtained. The DAS data may be obtained by (i) reading the DAS data from storage, (ii) receiving the DAS data from another device, (iii) generating the DAS data, and/or (iv) other methods. For example, the DAS data may be generated by collecting borehole seismic data using a DAS sensing element coupled to a structure of the well.

The DAS data may be based on a measurement made using a DAS sensing element positioned in the well. For example, the DAS sensing element may include a fiber optic wire or cable that measures vibrations from acoustic energy (e.g., strain rate) traveling through a geological formation surrounding the well.

At operation 402, a qualification process for the DAS data may be performed to identify whether any portion of the DAS sensing element was acoustically coupled to a structure of the well during the measurement in a manner that introduced at least one artifact to the DAS data. The qualification process may be performed using methods described with respect to FIGS. 2D-2E and/or by other methods.

Performing the qualification process may include performing a preconditioning process using the DAS data to obtain portions of the DAS data, where each of the portions of the DAS data include frequency domain data. The preconditioning process may be performed by (i) filtering the DAS data to isolate a frequency bandwidth of desired acoustic signal, (ii) transforming (e.g., using a Fourier transform function) the DAS data to the frequency domain to obtain amplitude spectra (e.g., frequency spectra) of the DAS data, and/or (iii) performing other noise reduction and/or signal enhancing processes using the DAS data.

In a first example, the qualification process may be performed by (i) performing a clustering analysis using the portions of the (preconditioned) DAS data to establish a set of clusters of the portions of the DAS data, (ii) qualifying each cluster of the set of clusters with respect to whether the at least one artifact is present, and (iii) qualifying portions of the DAS sensing element using corresponding clusters of the set of clusters with respect to whether each respective portion of the DAS sensing element is acoustically coupled to the structure in the manner that introduced the at least one artifact to the DAS data.

The clustering analysis may be performed by (i) providing a number of clusters to a clustering algorithm (e.g., a K-shape clustering algorithm), (ii) providing DAS data (e.g., frequency domain DAS data) to the clustering algorithm, and/or (iii) obtaining results of the clustering algorithm (e.g., the set of clusters).

Qualifying each cluster of the set of clusters with respect to whether the at least one artifact is present may include matching frequency domain data from members of each cluster to a template of a set of templates. For example, the frequency domain data for each cluster (e.g., a spectral shape of the cluster centroid) may be compared with spectral shapes of templates of the set of templates to identify differences in the spectral shapes, and the template associated with the smallest difference of the differences may be selected.

Each template of the set of templates may indicate spectral responses associated with different acoustic coupling conditions for DAS sensing elements; therefore, each template may indicate an acoustic coupling condition for DAS data of the associated cluster.

Portions of the DAS sensing element may be qualified by obtaining (e.g., reading, receiving) the acoustic coupling condition specified by the template(s) associated with the corresponding clusters.

In a second example, the qualification process may be performed by (i) obtaining a set of cross-correlation coefficients for portions of the DAS data, (ii) obtaining statistical characterizations of subsets of the set of cross-correlation coefficients, and (iii) qualifying portions of the DAS sensing element using a corresponding statistical characterization of the statistical characterizations with respect to whether each respective portion of the DAS sensing element is acoustically coupled to the structure in the manner that introduced the at least one artifact to the DAS data.

The set of cross-correlation coefficients for portions of the DAS data may be obtained by (i) reading the cross-correlation coefficients from storage, (ii) receiving the cross-correlation coefficients from another device, (iii) generating the cross-correlation coefficients, and/or (iv) other methods. For example, the cross-correlation coefficients may be generated by performing a cross-correlation process using portions (e.g., pairs) of frequency domain DAS data (e.g., amplitude spectra of the DAS data) and/or by other methods (e.g., using Euclidean distance and/or dynamic time warping (DTW) methods).

The statistical characterizations of subsets of the set of cross-correlation coefficients may be obtained by (i) reading the statistical characterizations from storage, (ii) receiving the statistical characterizations from another device, (iii) generating the statistical characterizations, and/or (iv) other methods. For example, the statistical characterizations may be generated by evaluating a function (e.g., an averaging function) that uses the subsets of the set of cross-correlation coefficients as input.

Qualifying the portions of the DAS sensing element may include (i) obtaining a threshold for the statistical characterizations, and for each portion of the portions of the DAS sensing element, (ii) comparing the corresponding statistical characterization to the threshold to ascertain whether the portion of the DAS sensing element is acoustically coupled to the structure in the manner that introduced the at least one artifact to the DAS data.

The threshold may be obtained by (i) reading the threshold from storage, (ii) receiving the threshold from another device, (iii) generating the threshold, and/or (iv) other methods. For example, the threshold may be generated by a subject matter expert based on historical experience (e.g., best practices), processing goals for the DAS data, and/or downstream use of the DAS data.

For each portion of the portions of the DAS sensing element, the corresponding statistical characterization may be compared to the threshold by evaluating whether the statistical characterization is inferior to the threshold. The portions of the DAS sensing element may be qualified based on the threshold evaluation, and the qualification may indicate whether each portion of the DAS sensing element is acoustically coupled to the structure in the manner that introduced the at least one artifact to the DAS data.

At operation 404, a determination may be made regarding whether any portion of the DAS sensing element was acoustically coupled to a structure of the well during the measurement in a manner that introduced at least one artifact to the DAS data. The determination may be made based on the acoustic coupling condition specified by the template(s) in the first example of operation 402 and/or based on the threshold evaluation of the second example of operation 402.

If the acoustic coupling condition and/or the threshold evaluation indicate that the DAS sensing element is acoustically coupled to the structure in the manner that introduced the at least one artifact to the DAS data, then the method may proceed to operation 406. Otherwise, the method may end following operation 404.

At operation 406, a remediation process to manage impacts of the at least one artifact on downstream use of the DAS data may be performed. The remediation process may be performed by (i) providing, to an operator of the well, information regarding the at least one portion of the DAS sensing element to facilitate supplementary measurements that are performed in a manner prescribed to manage acoustic coupling between the at least one portion of the DAS sensing element and the structure, (ii) identifying, from the DAS data, qualified DAS data for use in modeling of the well, and/or (iii) other methods.

For example, information regarding the at least one portion of the DAS sensing element may be provided to the operator of the well (or other entity) via (i) transmission via a message, (ii) storing in a storage with subsequent retrieval by a device of the operator, (iii) via a publish-subscribe system where the device of the operator subscribes to updates from a server storing the information, thereby causing a copy of the information to be propagated to the device of the operator, and/or via other processes. The device of the operator may be located, for example, at the well site, and/or at a management location of the well site.

Qualified DAS data may be identified from the DAS data by identifying DAS data that was acquired via portions of the DAS sensing element that were not acoustically coupled to a structure of the well during the measurement in a manner that introduced at least one artifact to the DAS data. For example, the qualified DAS data may be associated with (e.g., acquired via) portions of the DAS sensing element that were adequately coupled during acquisition of the qualified DAS data.

Downstream use of the DAS data may include (i) obtaining a well model for the well based, in part, on the DAS data, and (ii) selecting operating parameters for the well based, in part, on the well model, wherein the well is operated using the operating parameters.

The well model may be obtained by (i) reading the well model from storage, (ii) receiving the well model from another device, (iii) generating the well model, and/or (iv) other methods. The well model may be generated, for example, by performing a modeling process using properties deduced from the (qualified) DAS data and/or other data. For example, the (qualified) DAS data signal may have dependence on the structure of the well, materials in the well, properties of the geological formation, and/or other aspects of the well. This dependence may be used to deduce these properties based on the (qualified) DAS data. Refer to the discussion of FIG. 2B for more information regarding well modeling.

The operating parameters for the well may be selected by (i) obtaining an operation plan for the well, and (ii) identifying relevant operating parameters for a current phase of the well. The operation plan may be obtained by (i) reading the operation plan from storage, (ii) receiving the operation plan from another device, (iii) generating the operation plan, and/or (iv) other methods. For example, the operation plan and/or parameters thereof may be generated by providing the well model to a planning system. Refer to the discussion of FIG. 2C for more information regarding plan generation processes and operation plans.

Downstream use of the DAS data may also include (i) obtaining a geological model for a geological formation penetrated by the well based, in part, on the DAS data, and (ii) obtaining an energy product based, in part, on the geological model.

The geological model may be obtained by (i) reading the geological model from storage, (ii) receiving the geological model from another device, (iii) generating the geological model, and/or (iv) other methods. For example, the geological model may be included in a well model obtained by methods described with respect to FIG. 2B and/or by other methods.

The energy product may be obtained using hydrocarbons produced from the operated (e.g., completed) well. The energy product may be obtained by pumping fluid into and/or extracting fluid from the geological formation using the well.

The method may end following operation 406.

Thus, as illustrated above, embodiments disclosed herein may provide systems and methods usable to manage operation of a well by improving the quality and/or reliability of DAS data that may influence the determination of well operation plans by monitoring coupling quality of the DAS sensing element.

Any of the components illustrated in FIGS. 1A-4 may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high-level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In an embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in an embodiment can be implemented via multiple memory devices to provide for a given amount of system memory. Memory 503 may include one or more volatile storage (or memory) devices such as random-access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In an embodiment, to enable a thinner and lighter system design as well as to improve system responsiveness, this mass storage may be implemented via a solid-state device (SSD). In an embodiment, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs, or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a well, the method comprising:
obtaining distributed acoustic sensing (DAS) data, the DAS data being based on a measurement made using a DAS sensing element positioned in the well;
performing a qualification process for the DAS data to identify whether any portion of the DAS sensing element was acoustically coupled to a structure of the well during the measurement in a manner that introduced at least one artifact to the DAS data; and
in a first instance of the performing of the qualification process where at least one portion of the DAS sensing element was coupled to the structure in the manner that introduced the at least one artifact to the DAS data:
performing a remediation process to manage impacts of the at least one artifact on downstream use of the DAS data.

2. The method of claim 1, wherein performing the qualification process comprises:
performing a clustering analysis using portions of the DAS data to establish a set of clusters of the portions of the DAS data;
qualifying each cluster of the set of clusters with respect to whether the at least one artifact is present; and
qualifying portions of the DAS sensing element using corresponding clusters of the set of clusters with respect to whether each respective portion of the DAS sensing element is acoustically coupled to the structure in the manner that introduced the at least one artifact to the DAS data.

3. The method of claim 2, wherein performing the qualification process further comprises:
performing a preconditioning process using the DAS data to obtain the portions of the DAS data, and each of the portions of the DAS data comprising frequency domain data.

4. The method of claim 2, wherein qualifying each cluster of the set of clusters with respect to whether the at least one artifact is present comprises:
matching frequency domain data from members of each cluster to a template of a set of templates, and each template of the set of templates indicating spectral responses associated with different acoustic coupling conditions for DAS sensing elements.

5. The method of claim 1, wherein performing the qualification process comprises:
obtaining a set of cross-correlation coefficients for portions of the DAS data;
obtaining statistical characterizations of subsets of the set of cross-correlation coefficients; and
qualifying portions of the DAS sensing element using a corresponding statistical characterization of the statistical characterizations with respect to whether each respective portion of the DAS sensing element is acoustically coupled to the structure in the manner that introduced the at least one artifact to the DAS data.

6. The method of claim 5, wherein qualifying the portions of the DAS sensing element comprises:
obtaining a threshold for the statistical characterizations; and
for a portion of the portions of the DAS sensing element:
comparing the corresponding statistical characterization to the threshold to ascertain whether the portion of the DAS sensing element is acoustically coupled to the structure in the manner that introduced the at least one artifact to the DAS data.

7. The method of claim 1, wherein performing the remediation process comprises:
providing, to an operator of the well, information regarding the at least one portion of the DAS sensing element to facilitate supplementary measurements that are performed in a manner prescribed to manage acoustic coupling between the at least one portion of the DAS sensing element and the structure.

8. The method of claim 1, wherein performing the remediation process comprises:
identifying, from the DAS data, qualified DAS data for use in modeling of the well.

9. The method of claim 1, wherein downstream use of the DAS data comprises:
obtaining a well model for the well based, in part, on the DAS data; and
selecting operating parameters for the well based, in part, on the well model, wherein the well is operated using the operating parameters.

10. The method of claim 1, wherein downstream use of the DAS data comprises:
obtaining a geological model for a geological formation penetrated by the well based, in part, on the DAS data; and
obtaining an energy product based, in part, on the geological model.

11. A non-transitory machine-readable medium having instructions stored therein, which when executed by a processor, cause the processor to perform operations for managing operation of a well, the operations comprising:
obtaining distributed acoustic sensing (DAS) data, the DAS data being based on a measurement made using a DAS sensing element positioned in the well;
performing a qualification process for the DAS data to identify whether any portion of the DAS sensing element was acoustically coupled to a structure of the well during the measurement in a manner that introduced at least one artifact to the DAS data; and
in a first instance of the performing of the qualification process where at least one portion of the DAS sensing element was coupled to the structure in the manner that introduced the at least one artifact to the DAS data:
performing a remediation process to manage impacts of the at least one artifact on downstream use of the DAS data.

12. The non-transitory machine-readable medium of claim 11, wherein performing the qualification process comprises:
performing a clustering analysis using portions of the DAS data to establish a set of clusters of the portions of the DAS data;
qualifying each cluster of the set of clusters with respect to whether the at least one artifact is present; and
qualifying portions of the DAS sensing element using corresponding clusters of the set of clusters with respect to whether each respective portion of the DAS sensing element is acoustically coupled to the structure in the manner that introduced the at least one artifact to the DAS data.

13. The non-transitory machine-readable medium of claim 12, wherein performing the qualification process further comprises:
performing a preconditioning process using the DAS data to obtain the portions of the DAS data, and each of the portions of the DAS data comprising frequency domain data.

14. The non-transitory machine-readable medium of claim 12, wherein qualifying each cluster of the set of clusters with respect to whether the at least one artifact is present comprises:
matching frequency domain data from members of each cluster to a template of a set of templates, and each template of the set of templates indicating spectral responses associated with different acoustic coupling conditions for DAS sensing elements.

15. The non-transitory machine-readable medium of claim 11, wherein performing the qualification process comprises:
obtaining a set of cross-correlation coefficients for portions of the DAS data;
obtaining statistical characterizations of subsets of the set of cross-correlation coefficients; and
qualifying portions of the DAS sensing element using a corresponding statistical characterization of the statistical characterizations with respect to whether each respective portion of the DAS sensing element is acoustically coupled to the structure in the manner that introduced the at least one artifact to the DAS data.

16. A data processing system, comprising:
a processor; and
a memory coupled to the processor to store instructions, which when executed by the processor, cause the processor to perform operations for managing operation of a well, the operations comprising:
obtaining distributed acoustic sensing (DAS) data, the DAS data being based on a measurement made using a DAS sensing element positioned in the well,
performing a qualification process for the DAS data to identify whether any portion of the DAS sensing element was acoustically coupled to a structure of the well during the measurement in a manner that introduced at least one artifact to the DAS data, and
in a first instance of the performing of the qualification process where at least one portion of the DAS sensing element was coupled to the structure in the manner that introduced the at least one artifact to the DAS data:
performing a remediation process to manage impacts of the at least one artifact on downstream use of the DAS data.

17. The data processing system of claim 16, wherein performing the qualification process comprises:
performing a clustering analysis using portions of the DAS data to establish a set of clusters of the portions of the DAS data;
qualifying each cluster of the set of clusters with respect to whether the at least one artifact is present; and
qualifying portions of the DAS sensing element using corresponding clusters of the set of clusters with respect to whether each respective portion of the DAS sensing element is acoustically coupled to the structure in the manner that introduced the at least one artifact to the DAS data.

18. The data processing system of claim 17, wherein performing the qualification process further comprises:
performing a preconditioning process using the DAS data to obtain the portions of the DAS data, and each of the portions of the DAS data comprising frequency domain data.

19. The data processing system of claim 17, wherein qualifying each cluster of the set of clusters with respect to whether the at least one artifact is present comprises:
matching frequency domain data from members of each cluster to a template of a set of templates, and each template of the set of templates indicating spectral responses associated with different acoustic coupling conditions for DAS sensing elements.

20. The data processing system of claim 16, wherein performing the qualification process comprises:
obtaining a set of cross-correlation coefficients for portions of the DAS data;
obtaining statistical characterizations of subsets of the set of cross-correlation coefficients; and
qualifying portions of the DAS sensing element using a corresponding statistical characterization of the statistical characterizations with respect to whether each respective portion of the DAS sensing element is acoustically coupled to the structure in the manner that introduced the at least one artifact to the DAS data.
